(19) United States
(12) Patent Application Publication
(10) Pub. No.: US 2024/0194892 A1
(43) Pub. Date: Jun. 13, 2024

(54) NON-AQUEOUS ELECTROLYTE RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Kazutaka YOSHIKAWA, Hamamatsu-shi (JP); Shotaro DEGUCHI, Toyota-shi (JP); Ryotaro SAKAI, Toyota-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/529,799

(22) Filed: Dec. 5, 2023

(30) Foreign Application Priority Data
Dec. 9, 2022 (JP) 2022-197130

(51) Int. Cl. H01M 4/66; H01M 10/0587; H01M 10/42

(52) U.S. Cl. CPC H01M 4/667; H01M 10/0587; H01M 10/4235; H01M 10/0525

(57) ABSTRACT

A non-aqueous electrolyte rechargeable battery includes a positive electrode plate, a negative electrode plate, a separator, and a non-aqueous electrolyte solution. The positive electrode plate includes a current collector, a mixture layer formed on part of at least one surface of the current collector, and an insulating protective layer formed on the at least one surface of the current collector. The insulating protective layer is adjacent to the mixture layer. The insulating protective layer includes an interposed portion located between the mixture layer and the current collector. The insulating protective layer further includes a cavity extending between the interposed portion and the current collector. The cavity is dimensioned to be 3 μm or greater in a thickness direction of the positive electrode plate and in a range of 5 to 100 μm, inclusive, in a widthwise direction of the positive electrode plate.

### BACKGROUND

### 1. Field

The following description relates to a non-aqueous electrolyte rechargeable battery, and more specifically, to a non-aqueous electrolyte rechargeable battery that mitigates the effect of high-rate deterioration.

### 2. Description of Related Art

A non-aqueous electrolyte rechargeable battery such as a lithium-ion rechargeable battery is light in weight and high in energy density, and thereby used as a preferred high-output power supply installed in vehicles, stationary power storage equipment, and the like. Such a non-aqueous electrolyte rechargeable battery includes a rolled-type electrode body that is an electricity storage element formed by a positive electrode, a negative electrode, a separator insulating the positive and negative electrodes from each other, and the like. The electrode body is rolled into a columnar shape or an elliptical columnar shape and accommodated in a battery case. The positive electrode and the negative electrode of such an electrode body are designed such that a negative electrode mixture layer is wider than a positive electrode mixture layer. Thus, the negative electrode mixture layer opposes a positive electrode current collector, from which metal of the positive electrode current collector is exposed, with the separator located in between. Short circuiting between the positive electrode and the negative electrode will not occur under a normal situation because of the separator. However, when lithium or metal particles deposit on the negative electrode, short circuiting may occur through the separator and generate heat.

In order to avoid such short circuiting, Japanese Laid-Open Patent Publication No. 2017-157471 discloses an example of a positive electrode including a positive electrode current collector foil, an insulating protective layer containing an insulative material, and a positive electrode mixture layer containing a positive electrode active material. The positive electrode mixture layer and the insulating protective layer are formed on at least one surface of the positive electrode current collector foil of a positive electrode plate.

Such an insulating protective layer covers a metal plate forming the positive electrode current collector with an insulator. This effectively prevents short circuiting with a negative electrode mixture layer through the separator even when lithium or fine metal particles deposit on the negative electrode.

Further, Japanese Laid-Open Patent Publication No. 2017-157471 discloses a structure in which the positive electrode mixture layer overlaps and covers the insulating protective layer. This avoids delamination of the insulating protective layer from the positive electrode current collector foil.

### SUMMARY

In a non-aqueous electrolyte rechargeable battery, an electrolyte moves when charging and discharging are performed at a high rate. In this case, if the insulating protective layer hinders the movement of a non-aqueous electrolyte solution within the battery cell, the concentration of the non-aqueous electrolyte solution becomes uneven. This may result in deterioration of the battery, or “high-rate deterioration”. In particular, although the invention described in Japanese Laid-Open Patent Publication No. 2017-157471, in which the insulating protective layer is disposed between the positive electrode mixture layer and the positive electrode current collector foil, avoids delamination of the insulating protective layer, high-rate deterioration is likely to occur at such a portion where the insulating protective layer is disposed between the positive electrode mixture layer and the positive electrode current collector foil.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a non-aqueous electrolyte rechargeable battery includes a positive electrode plate, a negative electrode plate, a separator insulating the positive electrode plate and the negative electrode plate, and a non-aqueous electrolyte solution. The positive electrode plate includes a positive electrode current collector, a positive electrode mixture layer formed on part of at least one surface of the positive electrode current collector, and an insulating protective layer formed on the at least one surface of the positive electrode current collector. The insulating protective layer is adjacent to the positive electrode mixture layer. The insulating protective layer includes an interposed portion located between the positive electrode mixture layer and the positive electrode current collector. The insulating protective layer further includes a cavity extending between the interposed portion and the positive electrode current collector. The cavity is dimensioned to be 3 μm or greater in a thickness direction of the positive electrode plate and in a range of 5 to 100 μm, inclusive, in a widthwise direction of the positive electrode plate.

In the non-aqueous electrolyte rechargeable battery, the positive electrode plate, the negative electrode plate, and the separator may form a rolled-type electrode body. The interposed portion may have a width in a range of 0.2 to 1.0 mm, inclusive, in a direction orthogonal to a rolling direction of the rolled-type electrode body.

In the non-aqueous electrolyte rechargeable battery, the insulating protective layer, excluding the cavity, may have a porosity in a range of 42% to 55%, inclusive.

Other features and aspects will be apparent from the following detailed description, the drawings, and the claims.

### BRIEF DESCRIPTION OF THE DRAWINGS

FIG. 1 is a perspective view schematically showing the structure of a lithium-ion rechargeable battery in accordance with the present embodiment.

FIG. 2 is a diagram schematically showing the structure of a rolled-type electrode body in accordance with the present embodiment.

FIG. 3 is a cross-sectional view schematically showing the structure of stacking of the electrode body of the lithium-ion rechargeable battery.

FIG. 4 is an enlarged diagram of a portion A shown in FIG. 3, schematically showing an interfacial portion B between a positive electrode mixture layer and an insulating protective layer in a coating step of the present embodiment.

FIG. 5 is a flowchart illustrating a method for manufacturing a positive electrode plate of the present embodiment.

FIG. 6 is a perspective view illustrating the coating step.

FIG. 7 is a perspective view schematically showing a first nozzle and a second nozzle of a coater including a cross section of the coater taken along C-C portion shown in FIG. 6.

FIG. 8 is a schematic diagram showing a state of the positive electrode plate when the coating step (S3) is started.

FIG. 9 is a schematic diagram showing a state of the positive electrode plate, a flow of an insulating protective paste, and a flow of a positive electrode mixture paste during the coating step (S3).

FIG. 10 is a schematic diagram showing a state of the positive electrode plate after the coating step (S3) is completed.

FIG. 11 is a schematic diagram showing a state of the insulating protective paste and a flow of the positive electrode mixture paste after the coating step (S3) is completed.

FIG. 12 is a schematic diagram showing a completed positive electrode plate.

FIG. 13 is a schematic diagram showing the insulating protective layer being separated due to an excessively large contact angle.

FIG. 14 is a schematic diagram showing an enlarged view of a cavity shown in FIG. 12.

FIG. 15 is a table showing experiments of the present embodiment.

FIG. 16 is a schematic diagram showing the structure of a positive electrode plate known in the art.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Present Embodiment

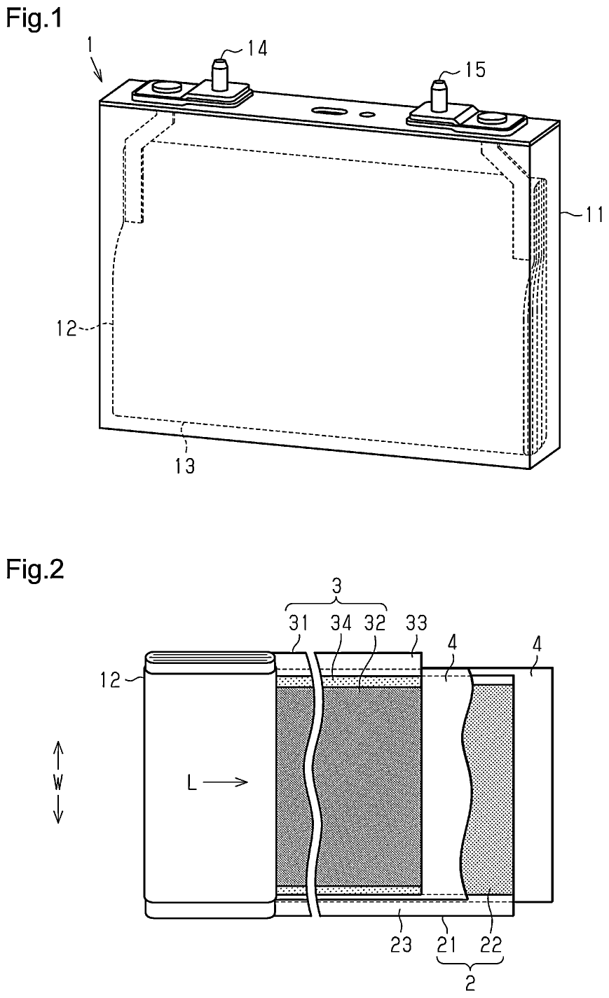

A non-aqueous electrolyte rechargeable battery in accordance with the present disclosure will now be described with an embodiment of a lithium-ion rechargeable battery 1 with reference to FIGS. 1 to 15.

### Problems of Prior Art

FIG. 16 is a schematic diagram showing a positive electrode plate 3 known in the art. As stated in the description of Japanese Laid-Open Patent Publication No. 2017-157471 and as shown in FIG. 16, an insulating protective layer 34 is disposed adjacent to the two ends of a positive electrode mixture layer 32 on a positive electrode current collector 31 so that occurrence of a micro-short-circuit is avoided. Further, the positive electrode mixture layer 32 is arranged overlapping the insulating protective layer 34 so that delamination of the insulating protective layer 34 is avoided.

However, in the lithium-ion rechargeable battery 1, an electrolyte moves within the positive electrode mixture layer 32 when charging and discharging are performed at a high rate. In the structure of the known art shown in FIG. 16, the insulating protective layer 34 has a high insulation property. Thus, if there is not enough of a non-aqueous electrolyte solution 13, the movement of the electrolyte is hindered and the concentration of the electrolyte becomes uneven. This may cause the problem of deterioration of the battery, or “high-rate deterioration”.

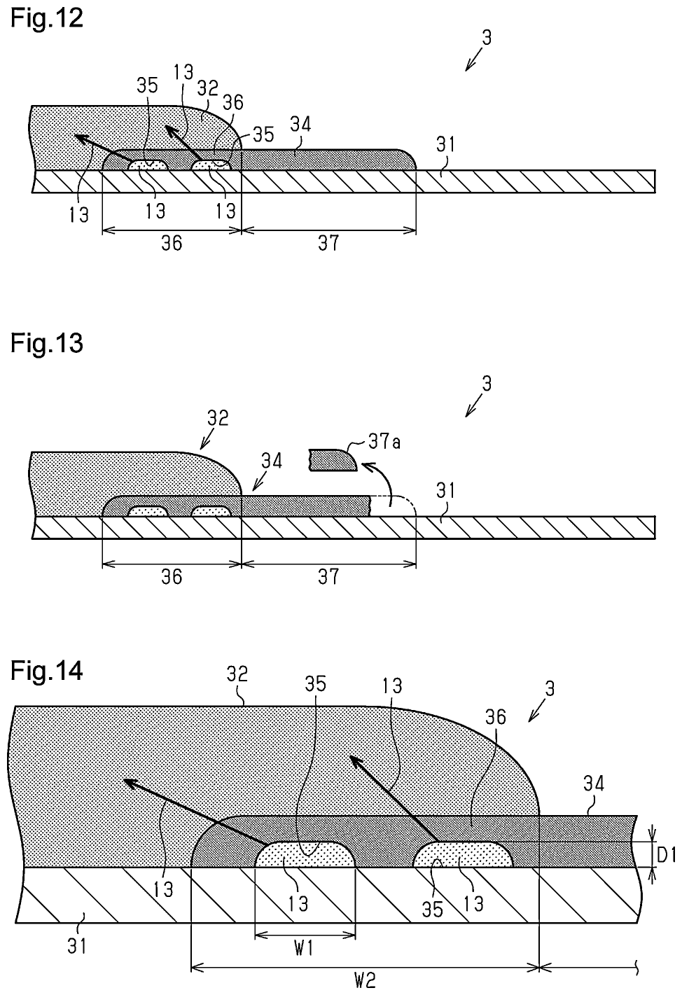

FIG. 12 is a schematic diagram showing a positive electrode plate 3 of the present embodiment. To solve the above problem, the positive electrode plate 3 of the lithium-ion rechargeable battery 1 of the present embodiment includes cavities 35 in the interfacial portion between the insulating protective layer 34 and the positive electrode current collector 31. After the non-aqueous electrolyte solution 13 is injected, the cavities 35 store the non-aqueous electrolyte solution 13.

As a result, even when charging and discharging are performed at a high rate, the non-aqueous electrolyte solution 13 stored in the cavities 35 supply the electrolyte to the positive electrode mixture layer 32. This mitigates the effect of high-rate deterioration caused by lack of electrolyte.

### Features of Present Embodiment

FIG. 14 is a schematic diagram showing an enlarged view of the cavities 35 in an interposed portion 36 shown in FIG. 12. The positive electrode plate 3 of the lithium-ion rechargeable battery 1 in accordance with the present embodiment includes the positive electrode mixture layer 32, the positive electrode current collector 31, and the insulating protective layer 34. The insulating protective layer 34 includes the interposed portion 36 and an end portion 37. The interposed portion 36 is disposed (or extended) between the positive electrode mixture layer 32 and the positive electrode current collector 31. The end portion 37 is exposed out of the positive electrode mixture layer 32. In the present embodiment, the interposed portion 36 refers to a portion where an insulating protective paste 34a covering the positive electrode current collector 31 is covered by a positive electrode mixture paste 32a in a coating step (S3).

In the present embodiment, the insulating protective layer 34 includes the cavities 35 extending between the interposed portion 36 and the positive electrode current collector 31. Each cavity 35 is dimensioned to have a height D1 of 3 μm or greater in a thickness direction of the positive electrode plate 3 and a width W1 in a range of 5 μm to 100 μm, inclusive, in a direction orthogonal to a rolling direction of the rolled-typed electrode body 12. In other words, the width W1 of the cavity 35 corresponds to the dimension of the cavity 35 in a direction (or rolling axis direction of rolled-type electrode body 12) in which the positive electrode mixture layer 32 and the insulating protective layer 34 are arranged next to each other. In the present embodiment, the cavities 35 are formed by drawing-in (catching) air between the interposed portion 36 of the insulating protective layer 34 and the positive electrode current collector 31. When the non-aqueous electrolyte solution 13 is injected into the lithium-ion rechargeable battery 1, the cavities 35 store the non-aqueous electrolyte solution 13. If an appropriately-sized cavity 35 is formed, a sufficient amount of the non-aqueous electrolyte solution 13 will be stored. However, when the cavity 35 is too large, the insulating protective layer 34 will easily delaminate from the positive electrode current collector 31. Accordingly, in the present embodiment, the values of the height D1 and the width W1 of the cavity 35 are optimized through experiments.

The interposed portion 36 is set to have a width W2 in a range of 0.2 mm to 1.0 mm, inclusive. When the width W2 of the interposed portion 36 is large enough, delamination of the insulating protective layer 34 from the positive electrode current collector 31 is effectively avoided. If the interposed portion 36 is too large, the reaction efficiently of the battery will decrease. Thus, in the present embodiment, experiments were conducted to optimize the value of the width W2 of the interposed portion 36.

The insulating protective layer 34, excluding the cavities 35, is set to have a porosity P in a range of 42% to 55%, inclusive. The porosity (%) is a value indicating the percentage of void in the entire insulating protective layer 34. A large porosity P(%) allows for satisfactory exchange of the non-aqueous electrolyte solution 13. A small porosity P(%) forms a structurally strong insulating protective layer 34. In the present embodiment, experiments were performed to optimize the porosity P based on these perspectives.

The present embodiment has the following operation. First, delamination of the insulating protective layer 34 from the positive electrode current collector 31 is avoided. Further, even when charging and discharging are performed at a high rate, electrolyte is supplied to the positive electrode mixture layer 32 from the cavities 35, formed in the interposed portion 36 of the insulating protective layer 34 and stores the non-aqueous electrolyte solution 13. This mitigates the effect of high-rate deterioration of the positive electrode active material that would result from lack of electrolyte.

### Structure of Present Embodiment

### Structure of Lithium-Ion Rechargeable Battery 1

The structure of the lithium-ion rechargeable battery 1 of the present embodiment will now be described in detail. The exemplified lithium-ion rechargeable battery 1 is an embodiment of a non-aqueous electrolyte rechargeable battery according to the present disclosure. The present disclosure is not limited to the structure described in the embodiment.

FIG. 1 is a perspective view schematically showing the external structure of the lithium-ion rechargeable battery 1 in accordance with the present embodiment. As shown in FIG. 1, the lithium-ion rechargeable battery 1 is structured as a battery cell. The lithium-ion rechargeable battery 1 includes a box-shaped battery case 11 having an opening in the upper side. The battery case 11 accommodates an electrode body 12. The battery case 11 is filled with the non-aqueous electrolyte solution 13 injected through a liquid injection hole. The battery case 11 is formed from a metal, such as an aluminum alloy, and forms a sealed battery container. Further, the lithium-ion rechargeable battery 1 includes a positive electrode external terminal 14 and a negative electrode external terminal 15 used for charging and discharging of the lithium-ion rechargeable battery 1. The shapes of the positive electrode external terminal 14 and the negative electrode external terminal 15 are not limited to those shown in FIG. 1.

FIG. 2 is a schematic diagram showing the structure of the rolled-type electrode body 12. The electrode body 12 is formed by a flat roll of a negative electrode plate 2 and the positive electrode plate 3 with separators 4 held in between. In the negative electrode plate 2, a negative electrode mixture layer 22 is formed on a negative electrode current collector 21 that serves as a substrate. The negative electrode plate 2 includes a negative electrode connection portion 23 where the negative electrode mixture layer 22 is not formed such that the negative electrode current collector 21 is exposed at one end of the electrode body 12 in a widthwise direction W (rolling axis direction) that is orthogonal to a direction in which the negative electrode current collector 21 is rolled (rolling direction L).

In the positive electrode plate 3, the positive electrode mixture layer 32 is formed on the positive electrode current collector 31 that serves as a substrate. As shown in FIG. 2, the positive electrode plate 3 includes a positive electrode connection portion 33 at the other end of the electrode body 12 (opposite to negative electrode connection portion 23) in the widthwise direction W (rolling axis direction) that is orthogonal to the direction in which the positive electrode current collector 31 is rolled (rolling direction L). The positive electrode mixture layer 32 is not formed on the positive electrode connection portion 33. Thus, the metal of the positive electrode current collector 31 is exposed.

Further, in the present embodiment, the insulating protective layer 34 is disposed adjacent to the end of the positive electrode mixture layer 32 and opposes the negative electrode mixture layer 22. The insulating protective layer 34 covers the exposed positive electrode current collector 31.

### Structure of Electrode Body 12

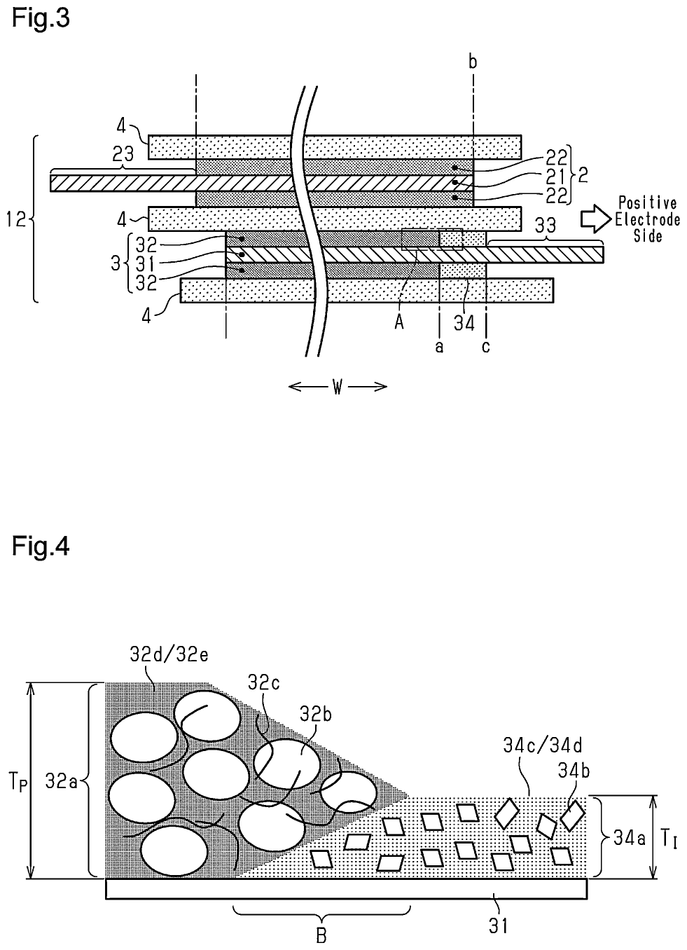

FIG. 3 is a cross-sectional view schematically showing the structure of stacking of the electrode body 12 of the lithium-ion rechargeable battery 1. As shown in FIG. 2, the basic structure of the electrode body 12 of the lithium-ion rechargeable battery 1 includes the negative electrode plate 2, the positive electrode plate 3, and the separators 4.

The negative electrode plate 2 includes the negative electrode mixture layer 22 on both surfaces of the negative electrode current collector 21, which serves as the negative electrode substrate. An end portion of the negative electrode current collector 21 located at one side of the electrode body 12 defines the negative electrode connection portion 23 where metal is exposed.

The positive electrode plate 3 includes the positive electrode mixture layer 32 on both surfaces of the positive electrode current collector 31, which serves as the positive electrode substrate. An end portion of the positive electrode current collector 31 located at the other side of the electrode body 12 defines the positive electrode connection portion 33 where the metal is exposed.

The negative electrode plate 2 and the positive electrode plate 3 are stacked with the separators 4 held in between. The stack is rolled in its longitudinal direction about the rolling axis to form the flat roll of the rolled-type electrode body 12.

### Non-Aqueous Electrolyte Solution 13

As shown in FIG. 1, the battery container formed by the battery case 11 is filled with the non-aqueous electrolyte solution 13. The non-aqueous electrolyte solution 13 of the lithium-ion rechargeable battery 1 is a composition in which a lithium salt is dissolved in an organic solvent. The lithium salt may include LiClO₄, LiPF₆, LiAsF₆, LiBF₄, LiSO₃CF₃, or the like. Examples of the organic solvent include a cyclic carbonate such as ethylene carbonate, propylene carbonate, butylene carbonate, and trifluoropropylene carbonate; a chain carbonate such as diethyl carbonate, dimethyl carbonate, ethyl methyl carbonate, and dipropyl carbonate; an ether compound such as tetrahydrofuran, 2-methyltetrahydrofuran, and dimethoxyethane; a sulfur compound such as ethyl methyl sulfone and butane sultone; and a phosphorus compound such as triethyl phosphate and trioctyl phosphate. The non-aqueous electrolyte solution may include one selected from the above or a mixture of two or more selected from the above. The non-aqueous electrolyte solution 13 is not limited to such a composition.

### Components of Electrode Body 12

The components of the electrode body 12, namely, the negative electrode plate 2, the positive electrode plate 3, and the separator 4, will now be described.

### Negative Electrode Plate 2

The negative electrode plate 2 has a structure in which the negative electrode mixture layer 22 is formed on both surfaces of the negative electrode current collector 21, which serves as the negative electrode substrate. The negative electrode current collector 21 is formed by a Cu foil in the embodiment. The negative electrode current collector 21 acts as the body and the base of the negative electrode mixture layer 22. Further, the negative electrode current collector 21 functions as a current collecting member that collects electricity from the negative electrode mixture layer 22. In the present embodiment, a negative electrode active material includes a material that is capable of storing and releasing lithium ions, namely, powders of a carbon material such as graphite or the like.

The negative electrode plate 2 is prepared by, for example, kneading the negative electrode active material, a solvent, and a binder, applying the kneaded negative electrode mixture paste to the negative electrode current collector 21, and then drying the paste.

### Positive Electrode Plate 3

FIG. 4 is an enlarged diagram of a portion A shown in FIG. 3, schematically showing an interfacial portion, or the interposed portion 36, between the positive electrode mixture layer 32 and the insulating protective layer 34 in a coating step of the present embodiment.

The positive electrode plate 3 includes the positive electrode current collector 31, the positive electrode mixture layer 32 applied to the positive electrode current collector 31, and the insulating protective layer 34.

### Positive Electrode Current Collector 31

The positive electrode plate 3 has a structure in which the positive electrode mixture layer 32 is formed on both surfaces of the positive electrode current collector 31, which serves as the positive electrode substrate. The positive electrode current collector 31 is formed by an Al foil in the embodiment. The positive electrode current collector 31 acts as the body and the base of the positive electrode mixture layer 32. Further, the positive electrode current collector 31 functions as a current collecting member that collects electricity from the positive electrode mixture layer 32.

An Al foil is described above as an example of the positive electrode substrate that forms the positive electrode current collector 31. The positive electrode substrate is formed from, for example, a conductive material including a metal having satisfactory electric conduction. The conductive material may include, for example, a material including aluminum or an aluminum alloy. The structure of the positive electrode current collector 31 is not limited to the above description.

### Positive Electrode Mixture Layer 32

The positive electrode mixture layer 32 will now be described with reference to FIG. 4. The positive electrode mixture layer 32 is formed by applying a positive electrode mixture paste 32a to the positive electrode current collector 31 and drying the applied positive electrode mixture paste 32a. The positive electrode mixture layer 32 includes positive electrode active material particles 32b and additives such as a conductor 32c, a binder 32d, a dispersant, and the like.

### Positive Electrode Mixture Paste 32a

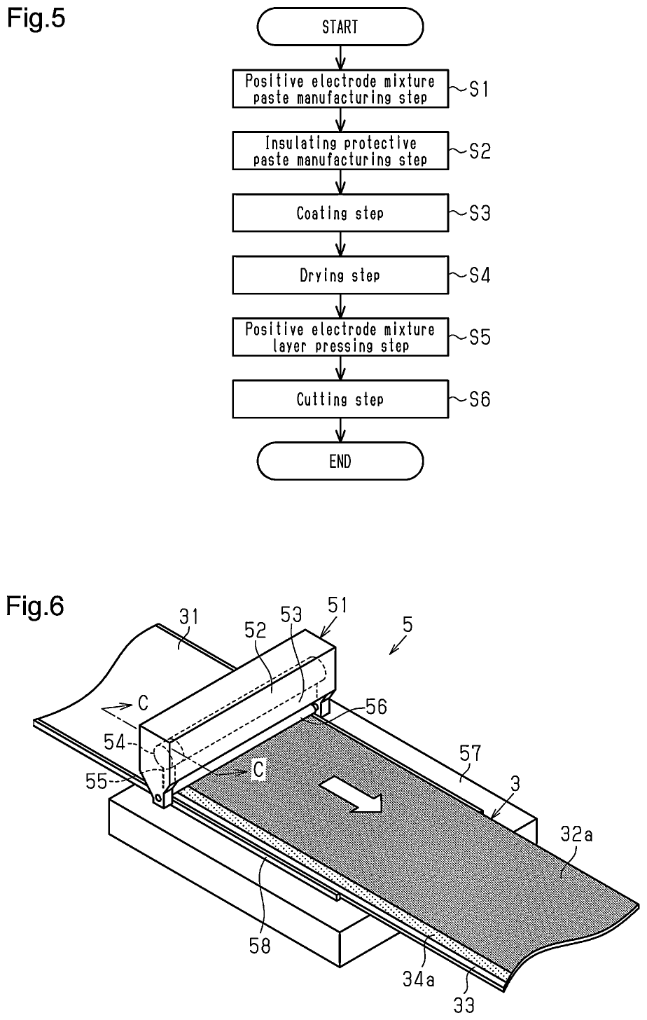

The positive electrode mixture paste 32a is obtained by adding a solvent 32e to the positive electrode active material particles 32b and the additives such as the conductor 32c, the binder 32d, the dispersant, and the like. In the coating step (S3) shown in FIG. 5, the positive electrode mixture paste 32a is applied to the positive electrode current collector 31 so as to form the positive electrode mixture layer 32. Then, in a drying step (S4), the positive electrode mixture paste 32a applied to the positive electrode current collector 31 is dried and adheres to the positive electrode current collector 31. At the stage shown in FIG. 4, the solvent 32e is mixed in the positive electrode mixture paste 32a. However, after the drying step (S4), the volatilized solvent 32e is absent from the positive electrode mixture layer 32.

In the present embodiment, the positive electrode mixture paste 32a is set to have a viscosity V in a range of 5000 to 50000 mPa·s at a shear rate of 0.1 s⁻¹.

### Composition of Positive Electrode Active Material Particles 32b

The primary particles of the positive electrode active material particles 32b include a lithium transition metal oxide having a layered crystalline structure. The lithium transition metal oxide includes one or more predetermined transition metal elements in addition to Li. Preferably, the transition metal element included in the lithium transition metal oxide is at least one of Ni, Co, and Mn. A preferred example of the lithium transition metal oxide includes every one of Ni, Co, and Mn.

The positive electrode active material particles 32b may include one or more types of elements in addition to the transition metal element (i.e., at least one of Ni, Co, and Mn). The additional element may include any element in group 1 (alkali metal such as sodium), group 2 (alkaline earth metal such as magnesium or calcium), group 4 (transition metal such as titanium or zirconium), group 6 (transition metal such as chromium or tungsten), group 8 (transition metal such as iron), group 13 (metalloid element such as boron or metal such as aluminum), or group 17 (halogen such as fluorine) of the periodic table.

In a preferred embodiment, the positive electrode active material particles 32b may have a composition (average composition) represented by the following general expression (1).

Li₁+xNi_{y}Co_{z}Mn_{(1-y-z)}MA_{α}MB_{β}O₂ (1)

In expression 1, the “x” may be a real number that satisfies 0≤x≤0.2. The “y” may be a real number that satisfies 0.1<y<0.6. The “z” may be a real number that satisfies 0.1<z<0.6. The “MA” is at least one type of metal element selected from W, Cr, and Mo. The “α” is a real number that satisfies 0<α≤0.01 (typically, 0.0005≤α≤0.01, for example, 0.001≤α≤0.01). The “MB” may be one or two or more types of elements selected from a group consisting of Zr, Mg, Ca, Na, Fe, Zn, Si, Sn, Al, B, and F. The “B” may be a real number that satisfies 0≤β≤0.01. The “B” may be substantially zero (that is, the oxide includes substantially no MB). To facilitate understanding, the chemical formula that expresses the lithium transition metal oxide, having a layered structure, indicates two as the composition ratio of O (oxygen). However, this numerical value should not be strictly interpreted, and some variations of the composition (typically included in range from 1.95 to 2.05, inclusive) are allowable.

### Conductor 32c

The conductor 32c is a material that forms a conductive path in the positive electrode mixture layer 32. When an appropriate amount of the conductor is mixed into the positive electrode mixture layer 32, the conductivity of the positive electrode is increased. This enhances the charging/discharging efficiency and the output characteristics of the battery. The conductor 32c of the present embodiment may include, for example, a carbon material such as carbon nanotubes (CNT) or carbon nanofibers (CNF). Preferably, the conductor 32c is string-shaped and has an aspect ratio of thirty or more.

### Binder 32d

The binder 32d may include, for example, polyvinylidene fluoride (PVdF), polytetrafluoroethylene (PTFE), polyacrylic acid, polyacrylate, or the like.

### Structure of Insulating Protective Layer 34

As shown in FIG. 2, in the positive electrode plate 3, the positive electrode mixture layer 32 is formed on the positive electrode current collector 31, and the insulating protective layer 34 is formed on the positive electrode current collector 31 at a position adjacent to the positive electrode mixture layer 32 and opposing an end of the negative electrode mixture layer 22. In the insulating protective layer 34, the insulative particles 34b are fixed in a state dispersed by the binder 32d. The insulating protective layer 34 is formed by applying an insulating protective paste 34a to a surface of the positive electrode current collector 31 along the end of the positive electrode mixture layer 32 and drying the paste.

### Insulating Protective Paste 34a

The insulating protective paste 34a is obtained by dispersing the insulative particles 34b in a liquid in which the solvent 34d is added to the binder 34c. Further, a dispersant is added to the insulating protective paste 34a so that the insulative particles 34b are uniformly dispersed in the paste.

The insulating protective layer 34 is formed by applying the insulating protective paste 34a to the positive electrode current collector 31 in the coating step (S3) shown in FIG. 5. Then, the insulating protective paste 34a is dried and adheres to the positive electrode current collector 31 in the drying step (S4). At the stage shown in FIG. 4, the solvent 34d is mixed in the insulating protective paste 34a. However, after the drying step (S4), the volatilized solvent 34d is absent from the insulating protective layer 34.

In the present embodiment, the insulating protective paste 34a is set to have a viscosity V in a range of 2000 to 4500 mPa·s, inclusive.

### Insulative Particles 34b

The insulative particles 34b are disposed between the negative electrode mixture layer 22 and the positive electrode current collector 31 to obtain electrical insulation thereof. Examples of the insulative particles 34b include ceramics obtained by firing a metal oxide having a high insulation property and a hardness that prevents entry of foreign matter. Specifically, the insulative particles 34b include particles of boehmite, alumina, or the like. In the present embodiment, the insulative particles 34b include boehmite.

### Boehmite

Boehmite is an aluminum hydroxide (γ-AlO(OH)) mineral, and is a component of aluminum ore bauxite. Boehmite exhibits a glassy to pearly luster, and has a Mohs hardness in a range of 3 to 3.5, inclusive, and a specific gravity in a range of 3.00 to 3.07, inclusive. Boehmite has high insulation properties, heat resistance and hardness. Industrially, boehmite may be used as an inexpensive flame-retardant additive for fire-resistant polymers.

Boehmite is represented by a chemical composition of AlO(OH) or Al₂O₃·H₂O, and is a chemically stable alumina monohydrate that is typically produced by performing a heating treatment or a hydrothermal treatment on alumina trihydrate in air. Boehmite has a high dehydration temperature in a range of 450 to 530° C., inclusive, and its shape can be controlled into various forms, such as plate-like, needle-like, and hexagonal plate-like, by adjusting production conditions. Further, the aspect ratio and the particle diameter of boehmite can be controlled by adjusting the production conditions.

### Binder 34c

The binder 34c may include, for example, polyvinylidene fluoride (PVdF), polytetrafluoroethylene (PTFE), polyacrylic acid, polyacrylate, or the like.

### Separator 4

The separator 4 may include a porous sheet formed from resin, such as polyethylene (PE), polypropylene (PP), or the like, so as to hold the non-aqueous electrolyte solution 13 between the positive electrode plate 3 and the negative electrode plate 2. Such a porous resin sheet may have a single-layer structure in which only one type of material is used. Alternatively, the porous resin sheet may have a multilayer structure in which various types of materials are combined.

### Method for Manufacturing Positive Electrode Plate 3

FIG. 5 is a flowchart illustrating a method for manufacturing the positive electrode plate 3 of the present embodiment. The method for manufacturing the positive electrode plate 3 of the present embodiment will now be described with reference to FIG. 5. In the method for manufacturing the positive electrode plate 3, a positive electrode mixture paste manufacturing step (S1) and an insulating protective paste manufacturing step (S2) are performed first. Then, a coating step (S3), a drying step (S4), a positive electrode mixture layer pressing step (S5), and a cutting step (S6) are performed.

### Positive Electrode Mixture Paste Manufacturing Step (S1)

First, the positive electrode mixture paste 32a is manufactured. The details of the positive electrode mixture paste 32a are as described above.

### Insulating Protective Paste Manufacturing Step (S2)

Next, the insulating protective paste 34a is manufactured. The details of the insulating protective paste 34a are also as described above.

### Coating Step (S3)

The coating step (S3) will now be described. The coating step (S3) is a step of simultaneously applying the positive electrode mixture paste 32a prepared in the positive electrode mixture paste manufacturing step (S1) and the insulating protective paste 34a prepared in the insulating protective paste manufacturing step (S2) to predetermined positions of the positive electrode current collector 31.

### Structure of Coater 5

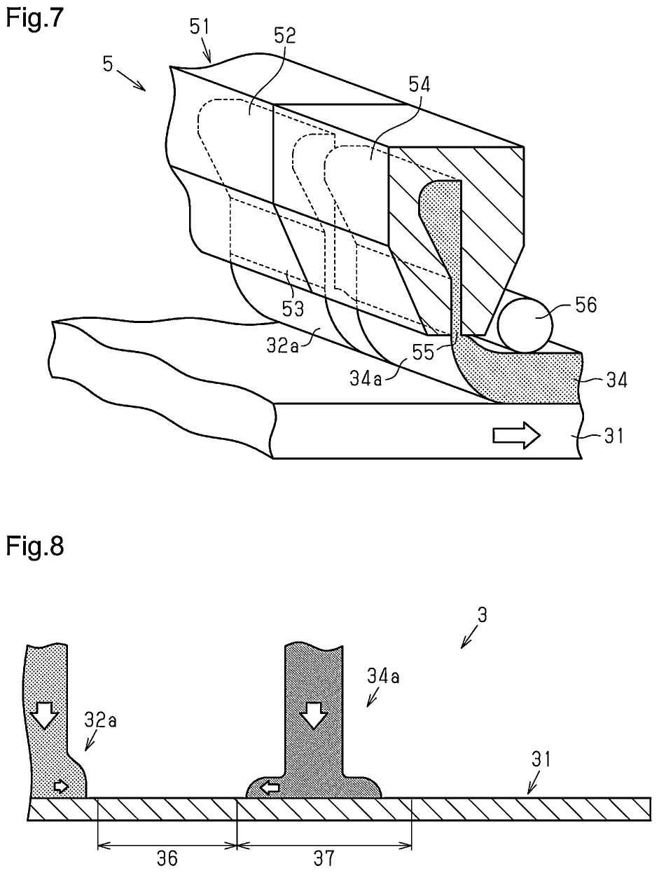

FIG. 6 is a perspective view showing the coating step (S3) performed by a coater 5. FIG. 7 is a perspective view schematically showing a first nozzle 53 and a second nozzle 55 of the coater 5 including a cross section of the coater 5 taken along C-C portion shown in FIG. 6. The coater 5 will now be described with reference to FIGS. 6 and 7.

As shown in FIG. 6, the coater 5 includes a stage 57 that acts as a base. The stage 57 includes a positioning guide 58 for conveying an uncut positive electrode current collector 31, which is a long strip of an Al foil. The positive electrode current collector 31 is drawn from a feeding reel (not shown) and conveyed on the stage 57 by a conveying means. A gate-shaped die nozzle 51 is arranged at an upstream end of the stage 57 in a direction in which the positive electrode current collector 31 is conveyed. The die nozzle 51 extends across the positive electrode current collector 31 in a direction orthogonal to the conveying direction. The die nozzle 51 includes a first die 52 that stores the positive electrode mixture paste 32a. The first die 52 is a compartment arranged at a position corresponding to where the positive electrode mixture layer 32 is formed. The first die 52 stores the positive electrode mixture paste 32a fed from a feeding means (not shown). Further, the die nozzle 51 includes a second die 54. The second die 54 is a compartment arranged at a position corresponding to where the insulating protective layer 34 is formed. The second die 54 stores the insulating protective paste 34a fed from a feeding means (not shown). The first die 52 and the second die 54 extend along the same straight line.

The first nozzle 53 extends from a lower part of the first die 52 to where the positive electrode mixture layer 32 of the positive electrode current collector 31 is formed on the stage 57. When the internal pressure of the first die 52 is increased by a pressurizing means (not shown), a predetermined amount of the positive electrode mixture paste 32a is discharged from the first nozzle 53 to where the positive electrode mixture layer 32 of the positive electrode current collector 31 is formed.

The second nozzle 55 extends from a lower part of the second die 54 to where the insulating protective layer 34 of the positive electrode current collector 31 is formed on the stage 57. When the internal pressure of the second die 54 is increased by a pressurizing means (not shown), a predetermined amount of the insulating protective paste 34a is discharged from the second nozzle 55 to where the insulating protective layer 34 of the positive electrode current collector 31 is formed.

A roller 56 flattens the applied positive electrode mixture paste 32a.

### Conditions of Coating Step (S3)

In the present embodiment, the viscosity V (mPa s) of the insulating protective paste 34a is set in a range of 2000 mPa·s to 4500 mPa·s, inclusive. Further, the viscosity V (mPa·s) of the positive electrode mixture paste 32a is set in a range of 5000 mPa·s to 50000 mPa·s, inclusive, at the shear rate of 0.1 s⁻¹.

Furthermore, a contact angle (°) between the positive electrode current collector 31 and the insulating protective paste 34a is set in a range of 40° to 56°, inclusive.

### Coating Method

FIG. 8 is a schematic diagram showing the state of the positive electrode plate 3 when the coating step (S3) is started. As shown in FIG. 7, the first nozzle 53 and the second nozzle 55 are separated from each other over a certain distance. As shown in FIG. 8, the positive electrode mixture paste 32a discharged from the first nozzle 53 and the insulating protective paste 34a discharged from the second nozzle 55 are in a state separated from each other immediately after the discharge.

In such a separated state, the positive electrode mixture paste 32a is applied to where the positive electrode mixture layer 32 of the positive electrode current collector 31 is formed. Further, in the separated state, the insulating protective paste 34a is applied to where the insulating protective layer 34 of the positive electrode current collector 31 is formed.

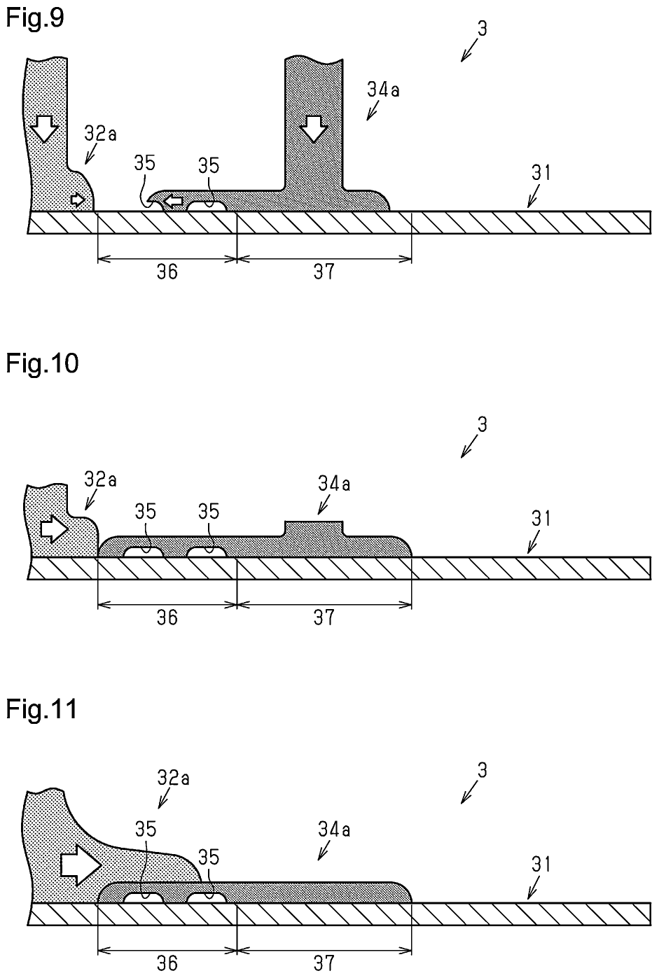

FIG. 9 is a schematic diagram showing the state of the positive electrode plate 3, the flow of the insulating protective paste 34a, and the flow of the positive electrode mixture paste 32a during the coating step (S3).

As shown in FIG. 9, after the positive electrode mixture paste 32a and the insulating protective paste 34a are applied, the positive electrode mixture paste 32a and the insulating protective paste 34a flow toward each other. In this case, the viscosities V are adjusted such that the insulating protective paste 34a has a higher fluidity than the positive electrode mixture paste 32a. Thus, the insulating protective paste 34a enters a region where the interposed portion 36 is to be formed before the positive electrode mixture paste 32a. The contact angle (°) between the insulating protective paste 34a and the positive electrode current collector 31 is set in a range of 40° to 56°, inclusive. This allows the insulating protective paste to flow smoothly on the surface of the positive electrode current collector 31. Accordingly, the insulating protective paste 34a flows to cover the portion where the interposed portion 36 of the positive electrode current collector 31 is formed while drawing-in (catching) air.

FIG. 10 is a schematic diagram showing the state of the positive electrode plate 3 after the coating step (S3) is completed. As shown in FIG. 10, the insulating protective paste 34a having a high fluidity contacts the positive electrode mixture paste 32a at the end of the interposed portion 36. In this case, the cavities 35 have been formed.

FIG. 11 is a schematic diagram showing the state of the insulating protective paste 34a and the flow of the positive electrode mixture paste 32a after the coating step (S3) is completed. As shown in FIG. 11, after the insulating protective paste 34a comes into contact with the positive electrode mixture paste 32a at the end of the interposed portion 36, the insulating protective paste 34a stops advancing. In contrast, since the discharge amount of the positive electrode mixture paste 32a is relatively large, the positive electrode mixture paste 32a moves beyond the insulating protective paste 34a and covers the insulating protective paste 34a. In this case, the contact surface between the insulating protective paste 34a and the positive electrode mixture paste 32a remains in the same position. In other words, the end of the insulating protective paste 34a contacting the positive electrode mixture paste 32a does not move.

FIG. 12 is a schematic diagram showing the completed positive electrode plate 3 of the present embodiment after the coating step (S3). When the coating is completed, the cavities 35 are formed between the interposed portion 36 of the insulating protective layer 34 and the positive electrode current collector 31. In this case, the width W2 of the interposed portion 36 in a direction orthogonal to the rolling direction is in a range of 0.2 mm to 1.0 mm, inclusive.

Further, each cavity 35 has the height D1 of 3 μm or greater in the thickness direction of the positive electrode plate 3 and the width W1 in a range of 5 μm to 100 μm, inclusive, in the widthwise direction W of the positive electrode plate 3. The cavities 35 may be dispersed as shown in FIG. 12. Alternatively, the cavities 35 may be combined with each other as long as the numerical values are in the above ranges.

### Drying Step (S4)

As described above, the drying step (S4) is performed after the coating step (S3) in a state in which the positive electrode mixture paste 32a and the insulating protective paste 34a are applied. In the drying step (S4), the solvent 32e of the positive electrode mixture layer 32 is volatilized so that the positive electrode mixture paste 32a becomes a solid and forms the positive electrode mixture layer 32. Further, the solvent 34d of the insulating protective layer 34 is also volatilized so that the insulating protective paste 34a becomes a solid and forms the insulating protective layer 34. The insulating protective layer 34 is stabilized in this state.

### Positive Electrode Mixture Layer Pressing Step (S5)

After the drying step (S4), the positive electrode mixture layer 32 and the insulating protective layer 34 shown in FIG. 12 already have a certain hardness. The insulating protective layer 34, excluding the cavities 35, after the positive electrode mixture layer pressing step (S5) is set to have the porosity P in a range of 42% to 55%, inclusive.

### Porosity P (%)

The porosity P (%) is a scale indicating the volume of pores such as cavities between particles. The porosity P (%) is generally proportional to a coefficient of water permeability. Thus, in the present embodiment, the porosity P (%) is used as an index of the efficiency at which the non-aqueous electrolyte solution 13 flows through the positive electrode mixture layer 32 in a cell.

Further, the porosity P (%) also serves as an index of the distances between the positive electrode active material particles 32b in the positive electrode mixture layer 32.

The porosity P (%) is measured by, for example, a liquid immersion method in which a porous sample is immersed in a liquid having a high wettability to saturate the pores with the liquid. Alternatively, the porosity P (%) may be measured using an optical method in which microscopic observation is conducted on a cross section of a sample to determine an area of the material and an area of the visible pores. Further, the porosity P (%) may be measured by, for example, mercury porosimetry in which an amount of mercury, having a high surface tension, injected into fine pores of a sample is measured with respect to the externally applied pressure so as to obtain the distribution and volume of the pores.

### Cutting Step (S6)

When the height D1, porosity P, and density are adjusted to desired values in the positive electrode mixture layer pressing step (S5), the manufacture of the positive electrode mixture layer 32 and the insulating protective layer 34 is completed. Then, in a cutting step (S6), the positive electrode current collector 31 is cut to a length that corresponds to the electrode body 12. This completes the manufacture of the positive electrode plate 3.

As shown in FIG. 2, the positive electrode plate 3 manufactured in this manner is stacked with the negative electrode plate 2 and the separators 4 and rolled to form the electrode body 12.

### EXPERIMENTAL EXAMPLES

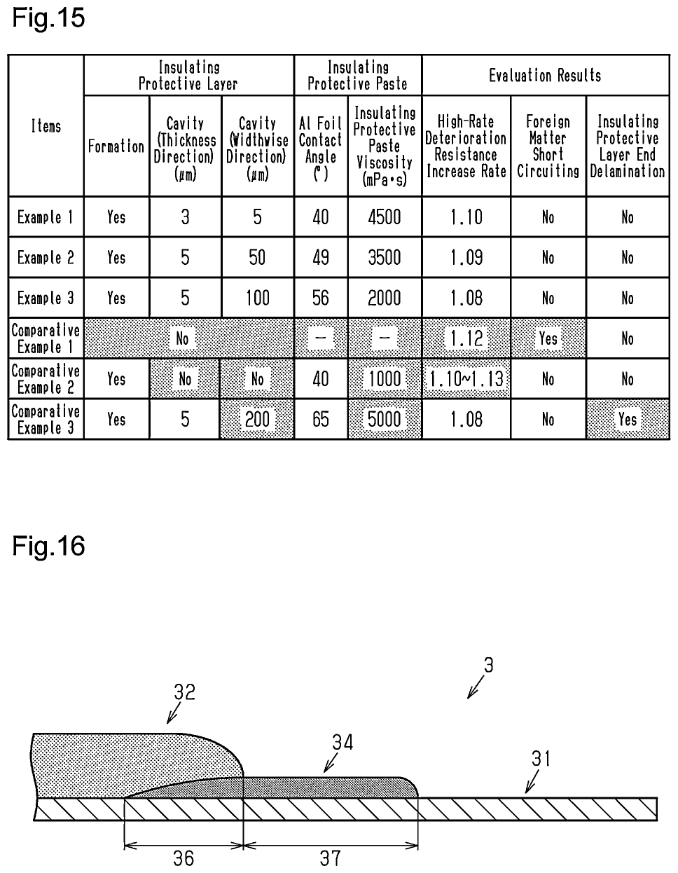

FIG. 15 is a table showing the experiments of the present embodiment. Experiments were conducted to compare Examples 1 to 3 and Comparative Examples 1 to 3 under different conditions. Conditions with respect to the insulating protective layer 34 include whether the insulating protective layer 34 is formed, the height D1 (μm) of the cavity 35 in the thickness direction, and the width W1 (μm) of the cavity 35 in the widthwise direction W. Further, conditions with respect to the insulating protective paste 34a include the contact angle (°) between the insulating protective paste 34a and the Al foil, which serves as the positive electrode current collector 31, and the viscosity V (mPa s) of the insulating protective paste 34a.

### CONDITIONS OF EXPERIMENTS

### Conditions of Example 1

The insulating protective layer 34 was formed. The cavity 35 had the height D1 of 3 μm in the thickness direction and the width W1 of 5 μm in the widthwise direction W. The contact angle (°) was 40°. The viscosity V of the insulating protective paste 34a was 4,500 mPa·s.

### Conditions of Example 2

The insulating protective layer 34 was formed. The cavity 35 had the height D1 of 5 μm in the thickness direction and the width W1 of 50 μm in the widthwise direction W. The contact angle was 49°. The viscosity V of the insulating protective paste 34a was 3,500 mPa·s.

### Conditions of Example 3

The insulating protective layer 34 was formed. The cavity 35 had the height D1 of 5 μm in the thickness direction and the width W1 of 100 μm in the widthwise direction W. The contact angle was 56°. The viscosity V of the insulating protective paste 34a was 2,000 mPa·s.

### Conditions of Comparative Example 1

The insulating protective layer 34 was not formed.

### Conditions of Comparative Example 2

The insulating protective layer 34 was formed, but did not include the cavity 35. The contact angle (°) was 40°. The viscosity V of the insulating protective paste 34a was 1,000 mPa·s.

### Conditions of Comparative Example 3

The insulating protective layer 34 was formed. The cavity 35 had the height D1 of 5 μm in the thickness direction and the width W1 of 200 μm in the widthwise direction W. The contact angle)(° was 65°. The viscosity V of the insulating protective paste 34a was 5,000 mPa·s.

### Evaluation Criteria of Experiments

The evaluations of the experiments were given based on criteria including a high-rate deterioration resistance increase rate (%), whether short circuiting caused by foreign matter was observed, and whether delamination of the end of the insulating protective layer was observed.

The high-rate deterioration resistance increase rate (%) is a rate (%) at which the internal resistance (CD-IR) increased after a charge-discharge cycle test in which charging and discharging are repeated at a large current (several tens of amperes or more) for a certain period of time. When the high-rate deterioration resistance increase rate (%) was less than or equal to 1.10, an evaluation of “acceptable” was given.

When short circuiting caused by foreign matter, such as fine metal powder, between the positive electrode connection portion 33 and the negative electrode mixture layer 22 was not observed after the above-described high-rate charging and discharging were repeated, an evaluation of “acceptable” was given.

When separation of the insulating protective layer end was not observed, an evaluation of “acceptable” was given.

FIG. 13 is a schematic diagram showing the insulating protective layer 34 being separated. As shown in FIG. 13, the end portion 37 of the insulating protective layer 34 is not covered by the positive electrode mixture layer 32, unlike the interposed portion 36. Thus, when the adhesion force of the insulating protective layer 34 and the positive electrode current collector 31 is small, a separation piece 37a may separate from the end portion 37. In the present embodiment, it is considered that whether the separation occurs depends on the contact angle between the Al foil of the positive electrode current collector 31 and the insulating protective paste 34a.

### EXPERIMENT RESULT

### Example 1

The high-rate deterioration resistance increase rate was 1.10, which is acceptable, a foreign matter short circuiting was not observed, which is acceptable, and delamination of the insulating protective layer end was not observed, which is acceptable. As a result, Example 1 satisfied the criteria.

### Example 2

The high-rate deterioration resistance increase rate was 1.09, which is acceptable, a foreign matter short circuiting was not observed, which is acceptable, and delamination of the insulating protective layer end was not observed, which is acceptable. As a result, Example 2 satisfied the criteria.

### Example 3

The high-rate deterioration resistance increase rate was 1.08, which is acceptable, a foreign matter short circuiting was not observed, which is acceptable, and delamination of the insulating protective layer end was not observed, which is acceptable. As a result, Example 3 satisfied the criteria.

### Comparative Example 1

The high-rate deterioration resistance increase rate was 1.12, which is unacceptable, a foreign matter short circuiting was observed, which is unacceptable, and delamination of the insulating protective layer end was not observed, which is acceptable. As a result, Comparative Example 1 failed to satisfy the criteria.

### Comparative Example 2

The high-rate deterioration resistance increase rate was 1.10 to 1.13, which is unacceptable, a foreign matter short circuiting was not observed, which is acceptable, and delamination of the insulating protective layer end was not observed, which is acceptable. As a result, Comparative Example 2 failed to satisfy the criteria.

### Comparative Example 3

The high-rate deterioration resistance increase rate was 1.08, which is acceptable, a foreign matter short circuiting was not observed, which is acceptable, and delamination of the insulating protective layer end was observed, which is unacceptable. As a result, Comparative Example 3 failed to satisfy the criteria.

### Summary of Experiments

The following findings were obtained from the above experiments.

### High-Rate Deterioration Resistance Increase Rate

In order to limit the high-rate deterioration resistance increase rate, the cavity 35 is set to have the height D1 (μm) in a range of 3 μm to 5 μm, inclusive, in the thickness direction and the width W1 (μm) in a range of 5 μm to 100 μm, inclusive, in the widthwise direction W.

Also, in order to obtain such a cavity 35, the contact angle between the Al foil of the positive electrode current collector 31 and the insulating protective paste 34a needs to be 40° or greater, and the viscosity V of the insulating protective paste 34a needs to be in a range of 2000 mPa·s to 4500 mPa·s, inclusive.

### Foreign Matter Short Circuiting

In order to avoid short circuiting caused by foreign matter, at least the insulating protective layer 34 needs to be formed.

### Delamination of End Portion 37 of Insulating Protective Layer 34

In order to avoid delamination of the end portion 37 of the insulating protective layer 34, the contact angle between the Al foil of the positive electrode current collector 31 and the insulating protective paste 34a needs to be 56° or less.

### ADVANTAGES OF PRESENT EMBODIMENT

(1) In the lithium-ion rechargeable battery 1 of the present embodiment, the insulating protective layer 34 mitigates the effect of the high-rate deterioration of the positive electrode mixture layer 32.
(2) The insulating protective layer 34 includes the interposed portion 36 located between the positive electrode mixture layer 32 and the positive electrode current collector 31. The insulating protective layer 34 further includes the cavities 35 located between the interposed portion 36 and the positive electrode current collector 31. Each cavity 35 is dimensioned to have the height D1 of 3 μm or greater in the thickness direction of the positive electrode plate 3 and the width W1 in a range of 5 μm to 100 μm, inclusive, in the widthwise direction W of the positive electrode plate 3. This limits the high-rate deterioration resistance increase rate.
(3) The interposed portion 36 has the width W2 of 0.2 mm or greater. This restricts delamination of the insulating protective layer 34.
(4) The interposed portion 36 has the width W2 of 1.0 mm or less. Thus, the reaction of the positive electrode mixture layer 32 is not hindered unnecessarily.
(5) The insulating protective layer 34, excluding the cavities 35, has the porosity P of 42% or greater. Thus, the cavities 35 readily store the non-aqueous electrolyte solution 13, and the non-aqueous electrolyte solution 13 is easily exchanged between the cavities 35 and the positive electrode mixture layer 32.
(6) The insulating protective layer 34, excluding the cavities 35, has the porosity P of 55% or less. This ensures the strength of the insulating protective layer 34 and avoids short circuiting caused by foreign matter entering through the negative electrode plate 2.
(7) In the present embodiment, the insulating protective paste 34a has the viscosity V (mPa·s) of 2000 mPa·s or greater. This forms the insulating protective layer 34 having a predetermined thickness.
(8) In the present embodiment, the insulating protective paste 34a has the viscosity V (mPa·s) of 4500 mPa·s or less. This spreads the insulating protective paste 34a more quickly than the positive electrode mixture paste 32a, thereby forming the interposed portion 36.
(9) The positive electrode mixture paste 32a has the viscosity V (mPa s) of 5000 mPa·s or greater at the shear rate of 0.1 s⁻¹. This spreads the positive electrode mixture paste 32a more slowly than the insulating protective paste 34a, thereby forming the interposed portion 36.
(10) The positive electrode mixture paste 32a has the viscosity V (mPa·s) of 50000 mPa·s or less at the shear rate of 0.1 s⁻¹. This forms the positive electrode mixture layer 32.
(11) The contact angle between the positive electrode current collector 31 and the insulating protective paste 34a is 40° or greater. This facilitates formation of the cavity 35 when the insulating protective paste 34a is applied.
(12) The contact angle between the positive electrode current collector 31 and the insulating protective paste 34a is 56° or less. This avoids separation of the insulating protective layer 34 from the positive electrode current collector 31 effectively.

### MODIFIED EXAMPLES

The above embodiment is an example of the present disclosure, and can be modified and implemented as follows.

In the present embodiment, the positive electrode mixture layer 32 and the insulating protective layer 34 are formed on both surfaces of the positive electrode current collector 31 so that the present disclosure is implemented on both surfaces. However, the present disclosure may be implemented on the positive electrode current collector 31 on only one surface. Further, the positive electrode mixture layer 32 and the insulating protective layer 34 may be formed on only one surface of the positive electrode current collector 31, and the present disclosure may be implemented on that surface.

In the present embodiment, an example of a non-aqueous electrolyte rechargeable battery is described as the lithium-ion rechargeable battery 1 that is a plate-shaped battery cell to be mounted on a vehicle. However, the non-aqueous electrolyte rechargeable battery is not limited to such a structure and may be, for example, cylindrical and/or stationary. Further, the electrode body 12 is not limited to a flat roll type and may be a stack of rectangular plate-shaped electrodes. In addition, there is no limitation to the shape of the positive electrode external terminal 14 and the negative electrode external terminal 15.

The drawings are provided to illustrate the present embodiment, and depiction of elements may be exaggerated or simplified for clarity. Thus, the present disclosure is not limited to the drawings.

The flowchart shown in FIG. 5 is an example of the present disclosure. Another step may be added or some of the steps may be deleted. Further, the steps may be performed in any order. For example, the positive electrode mixture paste manufacturing step (S1) and the insulating protective paste manufacturing step (S2) may be performed in any order. Alternatively, the drying step (S4) may be performed after the positive electrode mixture layer pressing step (S5).

The numerical values and ranges are merely examples, and can be optimized by one skilled in the art.

The composition, material characteristics, and the like of the positive electrode mixture paste 32a and the insulating protective paste 34a are examples of the present disclosure, and can be optimized by one skilled in the art.

The phrase “simultaneously applying” in the coating step (S3) does not have to mean strictly “simultaneously” as long as the problem that the present disclosure is to solve is solved. For example, the first nozzle 53 may be shifted from the second nozzle 55 in the conveying direction (downstream side).

The present embodiment is an embodiment of the present disclosure. It should be apparent to one skilled in the art that the present disclosure is not limited to the embodiment and can be implemented by adding, deleting, or changing the structure without departing from the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous electrolyte rechargeable battery, comprising:
a positive electrode plate;
a negative electrode plate;
a separator insulating the positive electrode plate and the negative electrode plate; and
a non-aqueous electrolyte solution, wherein:
the positive electrode plate includes a positive electrode current collector, a positive electrode mixture layer formed on part of at least one surface of the positive electrode current collector, and an insulating protective layer formed on the at least one surface of the positive electrode current collector, the insulating protective layer being adjacent to the positive electrode mixture layer;
the insulating protective layer includes an interposed portion located between the positive electrode mixture layer and the positive electrode current collector; and
the insulating protective layer further includes a cavity extending between the interposed portion and the positive electrode current collector, the cavity dimensioned to be 3 μm or greater in a thickness direction of the positive electrode plate and in a range of 5 to 100 μm, inclusive, in a widthwise direction of the positive electrode plate.

2. The non-aqueous electrolyte rechargeable battery according to claim 1, wherein:
the positive electrode plate, the negative electrode plate, and the separator form a rolled-type electrode body; and
the interposed portion has a width in a range of 0.2 to 1.0 mm, inclusive, in a direction orthogonal to a rolling direction of the rolled-type electrode body.

3. The non-aqueous electrolyte rechargeable battery according to claim 1, wherein the insulating protective layer, excluding the cavity, has a porosity in a range of 42% to 55%, inclusive.
